(19) United States
(12) Patent Application Publication
(10) Pub. No.: US 2021/0280898 A1
(43) Pub. Date: Sep. 9, 2021

(54) RECHARGEABLE HYBRID SODIUM METAL-SULFUR BATTERY

(71) Applicant: Field Upgrading USA, Inc., Broomfield, CO (US)

(72) Inventors: Sai Venkata Bhavaraju, Broomfield, CO (US); Marc Roger Flinders, Broomfield, CO (US); Thomas Ray Hinklin, Broomfield, CO (US); Steven William Hughes, Broomfield, CO (US); Mykola Makowsky, Broomfield, CO (US); Mathew Richard Robins, Broomfield, CO (US)

(21) Appl. No.: 17/192,793

(22) Filed: Mar. 4, 2021

Related U.S. Application Data
(60) Provisional application No. 62/985,250, filed on Mar. 4, 2020.

(51) Int. Cl. H01M 10/054; H01M 10/615; H01M 50/434; H01M 10/0569; H01M 4/58; H01M 4/38; H01M 4/74; H01M 4/80; H01M 4/66

(52) U.S. Cl. CPC H01M 10/054; H01M 10/615; H01M 50/434; H01M 10/0569; H01M 4/5815; H01M 4/381; H01M 2004/027; H01M 4/806; H01M 4/808; H01M 4/661; H01M 4/663; H01M 2300/0028; H01M 4/74

(57) ABSTRACT

The present technology provides rechargeable alkali metal-sulfur galvanic cells and batteries incorporating such cells as well as methods of using such cell and batteries. The present galvanic cells provide high specific energy and high power at lower cost than conventional alkali metal-sulfur cells.

### CROSS REFERENCE TO RELATED APPLICATIONS

This application claims priority to U.S. Provisional Application No. 62/985,250, filed Mar. 4, 2020, which is incorporated by reference in its entirety.

### BACKGROUND

Sodium-sulfur (Na—S) batteries provide high energy densities with acceptable safety, power densities, and cost. The theoretical specific energy of sodium-sulfur batteries is 1273 Wh/kg, based on the following overall reaction:

2Na+S [symbol] Na₂S

This is one of the highest known gravimetric energy densities for rechargeable batteries. The electrode materials (sodium, and sulfur) needed to produce these batteries are light, energetic, inexpensive, and readily available In contrast with other types of positive electrode materials, sulfur is relatively non-toxic, thereby making these batteries relatively safe for human contact. When sulfur is used as a positive electrode in a battery and sodium is used as the negative electrode, the battery may produce approximately 2.3V of output representative of the charged state open circuit voltage. Similarly, when Na₂S is used as a positive electrode active material in a battery and sodium is used as the negative electrode, the battery may produce approximately 2 V of output representative of the discharged state open circuit voltage.

The sodium-sulfur batteries that have been commercialized operate at elevated temperatures in excess of 300° C. Such temperatures are required to provide practical ionic conductivity with the sodium β″-alumina ceramic membranes typically used in sodium-sulfur batteries. At such temperatures, the sodium negative electrode and sulfur/polysulfide positive electrode are both molten and do not require any solvents to dissolve the positive electrode active material. Nonetheless, the high operating temperature has raised safety issues and requires higher-cost materials for the cell housing and complex thermal management systems, limiting the use of this technology to large stationary installations.

While lower temperature Na—S battery technology has been explored for some time, new challenges have arisen with such technologies as well. Ambient temperature Na—S batteries often suffer from low reversible capacity, self-discharging and serious cycling problems. At intermediate temperatures (e.g., 100-200° C.), Na—S batteries may suffer from low ionic conductivity of the ceramic membrane and low power density. In addition, due to the increasing insolubility of higher order polysulfides (e.g., Na₂S₄ and Na₂S₅) at the intermediate temperature range, it is necessary to rely on polar aprotic electrolytes. At the same time, irreversible formation of lower order polysulfides (e.g., Na₂S₂ and Na₂S₃) and sulfur give rise to capacity fade and cell failure, leading to poor utilization rates of the sulfur positive electrode active material during cell operation.

### SUMMARY

The present technology provides rechargeable sodium metal-sulfur galvanic cells and batteries incorporating such cells as well as methods of using such cell and batteries. The present galvanic cells provide high specific energy and high power at lower cost than conventional sodium metal-sulfur cells.

In one aspect, the present technology provides a rechargeable galvanic cell comprising a negative electrode compartment housing a negative electrode active material. The negative electrode active material comprises a liquid alkali metal wherein the alkali metal is selected from the group consisting of sodium and sodium alloys. The negative electrode compartment is in fluid communication with a first reservoir such that the liquid alkali metal may passively flow between the negative electrode compartment and the first reservoir as the galvanic cell charges or discharges. The cell includes a positive electrode compartment housing a mixture of positive electrode active material and a positive electrolyte. The positive electrode active material comprises elemental sulfur and/or polysulfides (Na₂Sₓ) depending on the charge state of the galvanic cell, wherein x has a value between 1 and 32. The positive electrolyte comprises a polar organic solvent, optionally comprising a polar protic organic solvent, that partially or completely dissolves the sulfur and Na₂Sₓ. The positive electrode compartment is in fluid communication with a pump and a second reservoir such that the pump may circulate the positive electrode active material and positive electrolyte between the second reservoir and the positive electrode compartment during charge or discharge of the galvanic cell. The cell further includes a sodium ion conductive ceramic membrane separating the negative electrode compartment from the positive electrode compartment.

In another aspect, the present technology provides a battery that includes one or more of the rechargeable galvanic cells described herein.

In yet another aspect, the present technology provides methods of operating the rechargeable galvanic cells described herein. The methods include charging or discharging the galvanic cell while circulating a mixture of positive electrolyte and positive electrode active material from the second reservoir through the positive electrode compartment and back to the second reservoir. The method may further include heating the mixture prior to it entering the positive electrode compartment to a temperature from about 100° C. to about 200° C. when the negative electrode active material is sodium or sodium alloy. The method may further include cooling the mixture after it exits the positive electrode compartment to a temperature of less than 100° C.

### BRIEF DESCRIPTION OF THE DRAWINGS

FIG. 1A is a schematic drawing of an illustrative galvanic cell of the present technology. FIG. 1B is a schematic of a system incorporating a galvanic cell of the present technology

FIG. 2. shows a graph of the conductivity of various Na₂Sₓ compounds in ethylene glycol, an illustrative polar protic solvent of the present technology.

FIG. 3 shows the first cycle charge-discharge curve for an illustrative embodiment of the present technology: a molten Na-NaSICON-Na₂S hybrid flow cell.

FIG. 4 shows cycling data for an illustrative embodiment of the present technology: a molten Na-NaSICON-Na₂S₃ hybrid flow cell.

FIG. 5 shows cycling data for an illustrative embodiment of the present technology: a molten Na-NaSICON-Na₂S₅ hybrid flow cell.

FIG. 6 shows charge and discharge cycling data for an illustrative embodiment of the present technology: a molten Na-NaSICON-Na₂S₅ hybrid flow cell at 120° C.

FIG. 7 shows the charge-discharge curve for an illustrative embodiment of the present technology, a molten Na-NaSICON-Na₂S₂ hybrid flow cell at 125° C., with glycerol as the positive electrolyte polar protic solvent.

FIG. 8 shows the charge-discharge curve for an illustrative embodiment of the present technology, a molten Na-NaSICON-Na₂S₄ hybrid flow cell at 125° C., with 80/20 w/w EG/NMP as the positive electrolyte polar organic solvent.

### DETAILED DESCRIPTION

The following terms are used throughout as defined below.

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

“Sodium ion conductive ceramic membrane” refers to any suitable ceramic membrane that prevents the negative electrode active material (e.g., sodium metal) from contacting the positive electrode active material (e.g., sulfur) and catholyte, but which allows sodium ions to be selectively transported from the negative electrode, through the membrane, to the positive electrode, and vice versa.

“Polar organic solvent” as used herein refers to polar protic and polar aprotic organic solvents with dielectric constants >10. The polar solvents have large dipole moments established between atoms with very different electronegativities, such as carbon, oxygen and hydrogen.

“Polar aprotic solvent” as used herein refers to a polar organic solvent that can act as a hydrogen bond acceptor, but has no hydrogen atoms that can act as a hydrogen bond donor. Examples include amides without hydrogen atoms on the amide nitrogen (e.g., dimethylformamide, N-methylpyrrolidone), sulfoxides (e.g., dimethylsulfoxide), ureas (e.g., N,N′-dimethylpropyleneurea), ethers (e.g., tetrahydrofuran, dioxane, diglyme, tetraglyme), carbonates (e.g., dimethyl carbonate, diethyl carbonate) and the like.

“Polar protic solvent” as used herein refers to organic and inorganic solvents with at least one hydrogen atom bonded to a heteroatom and which may engage in hydrogen bonding with a hydrogen bond acceptor. Examples of polar protic solvents include polar protic organic solvents such as alcohols, thiols (e.g. ethylene dithiol), and amides with hydrogen atoms on the amide nitrogen (e.g., primary amides such as formamide, acetamide; secondary amides such as N-methylformamide), and polar protic inorganic solvents such as water and ammonia. However, it will be understood by those skilled in the art that salts, such as ionic liquids, are not considered to be polar protic solvents for purposes of this technology.

“Alcohol” as used herein refers to C₁₋₈ compound with at least one hydroxyl group. Thus, in any embodiments, the alcohol may have 1, 2, 3, 4, 5, 6, 7, or 8 carbons or a range between and including any two of the forgoing values such as C₁₋₆, C₂₋₈, C₂₋₆, C₂₋₄, and the like. In any embodiments the alcohols may be polyhydric, having for example, two or three hydroxyl groups, such as glycols (e.g., ethylene glycol, propylene glycol, butane-1,4-diol, diethylene glycol, triethylene glycol, tetraethylene glycol) or triols, e.g., glycerol. However, it will be understood by those skilled in the art that functional groups with multiple oxygens or other heteroatoms, such as a carboxylic acid group or a hydroxylamine group, is not an alcohol for use with the present technology. Further, salts, such as ionic liquids, even if they contain a hydroxyl group, are not considered to be alcohols for use with the present technology.

In one aspect, the present technology provides a rechargeable Na—S galvanic cell based on the following cell/battery discharge/charge reactions where sodium metal is used as the negative electrode active material and sulfur is used as the positive electrode active material:

Positive Electrode Reactions: 2Na⁺+⅛S₈+2e⁻ [symbol] Na₂S

Polysulfides of various orders (e.g., Na₂Sₓ where x is an integer from 1 to 32)—and ultimately sulfur-will be formed at the positive electrode during this conversion. It will be understood that the positive electrode active material may include mixtures of sodium sulfide and polysulfides as well as sulfur and that the equivalent measured Na₂Sₓ species may include fractional values of x. For example, an equimolar mixture of Na₂S and Na₂S₂ may be measured as Na₂S_{1.5}.

Negative Electrode Reactions: Na [symbol] Na⁺+e⁻

The rechargeable galvanic cell may include:
a negative electrode compartment housing a negative electrode active material, wherein
   the negative electrode active material comprises a liquid alkali metal wherein the alkali metal is selected from the group consisting of sodium and sodium alloys, and
   the negative electrode compartment is in fluid communication with first reservoir such that the liquid alkali metal may passively flow between the negative electrode compartment and the first reservoir as the galvanic cell charges or discharges;
a positive electrode compartment housing a mixture of positive electrode active material and a positive electrolyte, wherein
   the positive electrode active material comprises elemental sulfur and/or Na₂Sₓ depending on the charge state of the galvanic cell, wherein x has a value between 1 and 32,
   the positive electrolyte comprises a polar organic solvent that partially or completely dissolves the Na₂Sₓ, and
   the positive electrode compartment is in fluid communication with a pump and a second reservoir such that the pump may circulate the positive electrode active material and positive electrolyte between the second reservoir and the positive electrode compartment during charge or discharge of the galvanic cell; and
sodium ion conductive ceramic membrane separating the negative electrode compartment from the positive electrode compartment.

As noted above, the negative electrode active material may include a liquid alkali metal, i.e., sodium or alloys of sodium. In any embodiments, the negative electrode active material may include liquid sodium. In any embodiments, the negative electrode active material may include a liquid sodium alloy. It will be understood by those skilled in the art that suitable sodium alloys are predominantly composed of sodium metal. In any embodiments, the sodium alloy is at least 80 wt % sodium metal, e.g., at least 80 wt %, at least 85 wt %, at least 90 wt %, at least 95 wt %, at least 96 wt %, at least 97 wt %, at least 98 wt %, at least 99 wt % or a range between and including any two of the foregoing values. For example, in any embodiments, the sodium alloy may be from 80 wt % to 99 wt % sodium metal. Alloys of the alkali metal may include, e.g., alloys with one or one or more of Si, Ge, Sn, Pb, Hg, Cs, Sb, Bi, Zn, Al, Ti, Co, Ni, Mn, and Cd. In any embodiments, the liquid alkali metal may be a sodium alloy that includes Cs. In certain embodiments, where the membrane is, e.g., β″-alumina, the sodium alloy may also include potassium. The non-sodium metal may be 1 wt %, 2 wt %, 3 wt %, 4 wt %, 5 wt %, 6 wt %, 8 wt %, 10 wt %, 15 wt %, 20 wt %, or an amount between and including any two of the foregoing values.

During charge or discharge of the present galvanic cells and batteries, the negative electrode active material is in a liquid state at the temperature of operation. In any embodiments where the negative electrode active material is sodium, the temperature may about 100° C. to about 200° C., including, e.g., a temperature in a range between and including any two values selected from 100°, 110°, 120°, 130°, 140°, 150°, 160°, 170°, 180°, 190°, and 200° C. If alloys of sodium metal are used, the temperature employed shall be one at which the alloy is liquid, e.g., about 100⁰ to about 200° C.

In any embodiments, the positive electrode active material may include, depending on the charge state of the galvanic cell, elemental sulfur, alkali metal sulfide and/or alkali metal polysulfides. Thus, e.g., the positive electrode active material may include elemental sulfur (S₈), sodium sulfide (Na₂S) and/or sodium polysulfide (Na₂Sₓ where x is an integer from 1 to 8 or even higher, e.g., 1-32). In any embodiments, the present galvanic cell may include elemental sulfur and/or one or more of Na₂S, Na₂S₂, Na₂S₃, Na₂S₄, Na₂S₅, Na₂S₆, Na₂S₁₆ and Na₂S₃₂. The positive electrode active materials may be dissolved or dispersed in the polar organic solvent or solvent mixture to give the positive electrolyte.

The positive electrode active material is generally at least partially dissolved in the present polar organic solvents and solvent mixtures, such as those including polar protic organic solvents, optionally with polar protic inorganic solvents and polar aprotic solvents. In particular, polar protic organic solvents such as alcohols at least partially dissolve sodium sulfide (Na₂S) and the lower sodium polysulfides (Na₂Sₓ, x=2 or 3), which are poorly dissolved by many polar aprotic solvents used in ambient temperature and intermediate temperature sodium-sulfur batteries. Higher sodium polysulfides also exhibit good solubilities in, e.g., alcohols and solvent mixtures containing alcohols of the present technology. Thus, in any embodiments, positive electrolyte solutions of sodium sulfide and/or polysulfides, (e.g., Na₂Sₓ, x=2 to 32) may be prepared at concentrations of 0.5 M to 4 M (based on Na⁺) or for example, from 0.5 or 1 M to 3 M or 2 M to 3M.

Depending on the state of charge or discharge of the cell, the Na₂Sₓ composition of the positive electrode active material will change and may phase separate as the solubilities differ in the composition range from Na₂S to various polysulfides to elemental sulfur. In any embodiments, the polar organic solvent includes a polar protic solvent or mixtures thereof. Mixtures of polar protic solvents such as alcohols or alcohol and another polar protic solvent may be used to increase the solubility of Na₂S. For example, ethylene glycol-water mixture can be used to dissolve more of Na₂S rather than pure ethylene glycol. Thus, in any embodiments, the positive electrolyte may be a mixture of two or more polar protic solvents, such as alcohols or an alcohol in admixture with another polar protic solvent. To improve solubility with elemental sulfur, the positive electrolyte of the present technology may also include a polar aprotic solvent.

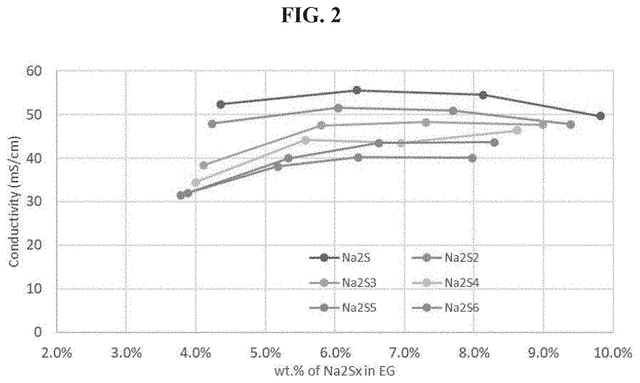

The ability of polar protic solvents to dissolve compositions in the range of Na₂S to Na₂S₂ as well as higher polysulfides up to Na₂S₆ and to at least partially dissolve even higher polysulfides or even sulfur (with addition of polar aprotic solvent) in the temperature range of 100 to 200° C. offers several advantages. First, it raises the utilizable positive electrode capacity to >80% of the theoretical positive sulfur electrode capacity (i.e., >80% of 1675 mAh/g). Second, the high sulfide/polysulfide solubilities of the present positive electrolytes lead to high Na⁺ ion conductivity that range from 30-60 mS/cm (FIG. 2) and support high charge and discharge currents in the present galvanic cells. Moreover, protic solvents are also often lower cost than their aprotic counterparts.

In any embodiments, the polar protic organic solvent may be selected from the group consisting of an alcohol, a thiol, a primary amide, and a secondary amide, and a mixture of any two or more thereof. In any embodiments, the polar protic organic solvent may be an alcohol, a mixture of two or more alcohols, or mixture of one or more alcohol(s) with another polar protic and/or aprotic solvent. The polar organic solvent or mixture of solvents (including any polar protic solvents) is selected so that it remains in the liquid phase over the operating temperature of the galvanic cell, such as, for example, from about 100° C. to about 200° C. (or a subset thereof). Thus, in any embodiments the organic solvent (including polar protic solvents) may be selected so as to remain liquid over the operating temperature range of about 100° C. to about 180° C., or about 110° C. to about 150° C., about 100° C. to about 125° C., about 100° C. to about 150° C., 125° C. to about 150° C., about 125° C. to about 175° C., about 125° C. to about 200° C. or about 150° C. to about 200° C. Examples of suitable polar protic organic solvents that are liquids in one or more of the specified temperature ranges include alcohols such as ethylene glycol, propylene glycol, 1,3-propananediol, 2,3-butanediol, 1,4-butanediol, dihydroxybenzyl alcohol (e.g., 3,5-dihydroxybenzyl alcohol, 3,4-dihydroxybenzyl alcohol, or 2,4-dihydroxybenzyl alcohol), cyclopentane-1,2-diol, cyclopentane-1,3-diol, cyclohexane-1,2-diol, cyclohexane-1,3-diol, cyclohexane-1,4,-diol, diethylene glycol, triethylene glycol, and tetraethylene glycol.

In any embodiments of the present rechargeable galvanic cells, the positive electrolyte may include one or more polar aprotic solvents, such as alcohols or thiols (including dithiols), optionally with a carboxylic acid, ammonia, water, or a combination of any two or more thereof. In any embodiments, the positive electrolyte may include alcohols such as ethylene glycol, propylene glycol, glycerol, cyclohexane diol, or a combination of any two or more thereof. The positive electrolyte may further include water. Depending on the state of charge or discharge of the cell, the Na₂S, composition of the positive electrode active material will change and may phase separate as the solubilities differ in the composition range from Na₂S to polysulfides to elemental sulfur. To increase the solubility of Na₂S, mixtures of alcohol(s) and water or a polar protic solvent(s) may be used, e.g., a mixture of ethylene glycol and water. Likewise, mixtures of alcohols with polar protic and/or polar aprotic solvents may be used to increase the solubility of higher polysulfides (e.g., Na₂S₆, Na₂S₇, Na₂S₈, . . . Na₂S₃₂) and S₈. For example, ethylene glycol/N-methyl-2-pyrrolidone (NMP) mixtures can be used to dissolve more polysulfides than ethylene glycol alone can. In this manner, the entire theoretical capacity of Na₂S through elemental sulfur can be realized in this galvanic cell. Nonetheless, as further described herein, it will be understood that the mixture of positive electrode active material and positive electrolyte may also be a mixture of one or more solid phases and one or more liquid phases.

In any embodiments, the polar organic solvent may be a mixture of polar protic and/or polar aprotic solvents, and may also include small amounts (less than 20 wt %, less than 10 wt %, less than 5 wt % of other protic solvents such as water or carboxylic acids). In any embodiments, the positive electrolyte may include a greater quantity of the polar protic solvent, optionally mixed with a lesser amount of polar aprotic solvent. In any embodiments, the positive electrolyte may include a greater quantity of an alcohol, optionally mixed with another (different) polar protic solvent and a lesser quantity of a polar aprotic solvent. In any embodiments, the positive electrolyte may include greater than 50 wt % of a polar protic solvent, and less than 50 wt % polar aprotic solvent, such as, e.g., 51/49 wt %, 55/45 wt %, 60/40 wt %, 70/30 wt %, 80/20 wt %, 90/10 wt/%, 95/5 wt %, and 99/1 wt % polar protic solvent to polar aprotic solvent, or a range between and including any two of the foregoing ratios. In any embodiments, the positive electrolyte may include greater than 50 wt % of an alcohol, mixture of alcohols, or mixture of alcohol(s) with other polar protic solvents and less than 50 wt % polar aprotic solvent, such as, e.g., 51/49 wt %, 55/45 wt %, 60/40 wt %, 70/30 wt %, 80/20 wt %, 90/10 wt/%, 95/5 wt %, and 99/1 wt % alcohol(s)/polar protic solvent to polar aprotic solvent, or a range between and including any two of the foregoing ratios. Examples of aprotic solvents that may be used include at least one of N,N-dimethylacetamide, N-methyl-2-pyrrolidone (NMP), N,N-dimethylformamide (DMF), dimethyl carbonate, diethyl carbonate, dioxane, dimethyl ether, tetraglyme, and diglyme. In any embodiments the positive electrolyte may include an alcohol (e.g., ethylene glycol or any of those described herein) with 2 wt % to 20 wt % polar protic solvent other than the alcohol (e.g., water, acetic acid, acetamide, and 1,3-propanedithiol). For example, the positive electrolyte may include 2, 4, 6, 8, 10, 12, 14, 16, 18, or 20 wt % polar protic solvent other than the alcohol(s), or a range between and including any two of the foregoing values. In any embodiments the positive electrolyte may include 1-40 wt % polar aprotic solvent (e.g., NMP or any of the ones described herein), e.g., 1, 2, 5, 10, 15, 20, 25, 30, 35, or 40 wt % polar aprotic solvent, or a range between and including any two of the foregoing values. In any embodiments, the electrolyte includes an alcohol, a polar protic solvent other than the alcohol, and a polar aprotic solvent in any of the amounts described herein. In any embodiments, the positive electrolyte may include 40-96% ethylene glycol, 0-20 wt % water, and 1-40 wt % NMP. The positive electrolyte may also include non-sodium salts such as ammonium hydroxide and tetramethyl ammonium hydroxide. However, in any embodiments the positive electrolyte may exclude non-sodium salts.

In any embodiments, to increase the capacity of the galvanic cell, additional sulfur/polysulfide/sodium sulfide above their solubility limit may be present and provide a semi-solid mixture of the polar organic solvent (e.g., alcohol and any other solvents described herein) and dissolved/undissolved positive electrode active materials. It will be understood when the positive electrolyte is a semisolid, it is a flowable semisolid. In any embodiments the positive electrolyte may include >0 wt % to 50 wt % undissolved positive electrode active material, i.e., sulfur and/or sodium polysulfide and/or sodium sulfide. In any such embodiments, the amount of undissolved positive electrode active material includes >0 wt %, 1 wt %, 2 wt %, 3 wt %, 4 wt %, 5 wt %, 10 wt %, 15 wt %, 20 wt %, 30 wt %, 40 wt %, or 50 wt %, or a range between and including any two of the foregoing values, e.g., >0 wt % to 40 wt %, >0 wt % to 30 wt %, or 1 wt % to 20 wt %.

The rechargeable galvanic cell of the present technology may further include a heat source and/or a cooling source for maintaining the temperature of the ceramic membrane, the negative electrode active material, and/or the positive electrode active material and positive electrolyte. When the negative electrode active material is sodium, the heat source and/or cooling source maintain a temperature from about 100° C. to about 200° C. For example, the heat source and/or cooling source may be one or more heat exchangers in fluid and/or thermal communication with the positive electrode compartment and which heats and/or cools the positive electrolyte to a temperature from about 100° C. to about 200° C. before it enters the positive electrode compartment.

In the present rechargeable galvanic cells, sodium ion conductive ceramic membrane separates the negative electrode active materials from the positive electrode active materials. In any embodiments, the sodium ion conductive ceramic membrane may be a sodium super ionic conductor (NaSICON), a sodium ion conducting garnet-like ceramic, a sodium β″-alumina membrane, or a sodium conducting glass ceramic. NaSICON compositions may include but are not limited to Na₃Zr₂Si₂PO₁₂, Na₁₊ₓSiₓZr₂P₃₋ₓO₁₂ (where x=1.6 to 2.4), Yittrium-doped NaSICON (e.g., Na_{1+x+y}Zr_{2-y}Y_{y}SiₓP₃₋ₓO₁₂, Na₁₊ₓZr_{2-y}Y_{y} SiₓP₃₋ₓO_{12-y}, where x=1.6-2.4, y=0-0.25), Na₁₊ₓZr₂X_{y}(PO₄)₃ wherein x is from 0 to 3, y is 0-1.5 and X is a dopant (e.g., Fe, Al, Ti, Hf, Co, Ni, Nb), and Fe-doped NaSICON (Na₃Zr_{2/3}Fe_{4/3}P₃O₁₂). A non-limiting example of a Na-β″-alumina membrane is Na_{(0.53-1.73)}Li_{(0.28-0.32)}Al_{(10.66-10.72)}O₁₇. In any embodiments, the sodium ion conducting ceramic membrane may be a sodium ion conducting garnet-like ceramic with the general formula of AₓB₂C₃O₁₂, where A is the alkali metal ion with x=3-9, (B=Te⁶⁺, Ta⁵⁺, Nb⁵⁺, Zr⁴⁺; C═La³⁺, Y³⁺, Nd³⁺). Non-limiting examples of a Na-conducting ceramic glass include sodium phosphate, such as xNa₂O.yP₂O₅, sodium silicate, such as xNa₂O.ySiO₂, sodium borate, such as xNa₂O.yB₂O₃, sodium aluminate, such xNa₂O.yAl₂O₃, and mixtures of any two or more thereof, in any of the foregoing the molar ratio of x:y may range from 1:3 to 3:1, 1:2 to 3:1, 1:2 to 2:1, 1:2 to 1:1, 1:3 to 2:1, or 1:3 to 1:1.

In any embodiments, the rechargeable galvanic cell may further include a positive electrode current collector disposed in the positive electrode compartment. The positive electrode current collector is constructed to ensure electrical contact with the positive electrolyte, no matter how the positive active material changes within the positive electrolyte. In other words, the positive electrode current collector is electrically connected with the liquid (dissolved) or solid (undissolved) positive electrode active material and the polar protic solvent regardless of physical changes in the mixture. The positive electrode current collector may include nickel foam, nickel mesh, carbon foam, or carbon felt.

An electrical conductor such as carbon particles may be used to increase the electrical conductivity of the positive electrode, e.g. by including carbon particles in the positive electrolyte. Similarly, ion conductivity enhancers may advantageously be added to positive electrolyte lacking significant sodium ion conductivity to improve conductivity and enhance current density. In any embodiments, the rechargeable galvanic cell may include conductivity enhancers selected from the group consisting of sodium halides (e.g., NaCl, NaBr, and NaI), sodium carboxylates (e.g., sodium formate, sodium acetate), sodium sulfur oxygenates (e.g., Na₂SO₄, Na₂SO₃, Na₂S₂O₃), sodium hydrosulfide (NaSH), sodium hydroxide, sodium cyanate, sodium carbonates (e.g., sodium carbonate, sodium bicarbonate), and combinations of any two or more thereof. Examples of suitable conductivity enhancers include NaI, NaOH, HCOONa, CH₃COONa, Na₂CO₃, NaOCN, Na₂SO₄, and combinations of any two or more thereof. In any embodiments, the positive electrolyte includes carbon particles which may form a semi-solid suspension with the alcohol or alcohol solvent mixture. In any embodiments, 0.01 wt % to 20 wt % sodium conductivity enhancers may be present in the positive electrolyte. For example, the positive electrolyte may include 0.01 wt %, 0.05 wt %, 0.1 wt %, 0.2 wt %, 0.5 wt %, 1 wt %, 2 wt %, 3 wt %, 4 wt %, 5 wt %, 6 wt %, 8 wt %, 10 wt %, 12 wt %, 15 wt %, 16 wt %, 18 wt %, and 20 wt % sodium ion conductivity enhancers or a range between and including any two of the foregoing values. Thus, for example, the positive electrolyte may optionally include 0.1 wt % to 20 wt %, 1 wt % to 18 wt % or 5 wt % to 15 wt % sodium ion conductivity enhancers. Conductivity enhancements of at least 10%-100% may be obtained with positive electrolyte that include such enhancers compared to the same electrolyte without such enhancers present. In some embodiments, the enhancement is at least 10%, at least 20%, at least 40%, at least 60%, at least 80%, at least 100% or a range between and including any two of the foregoing values.

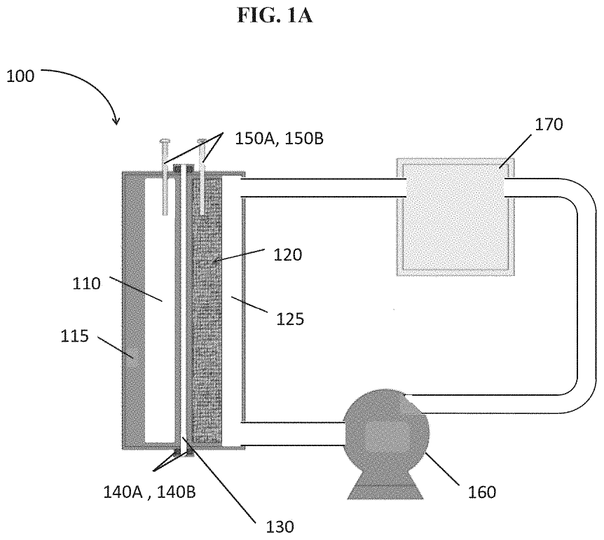

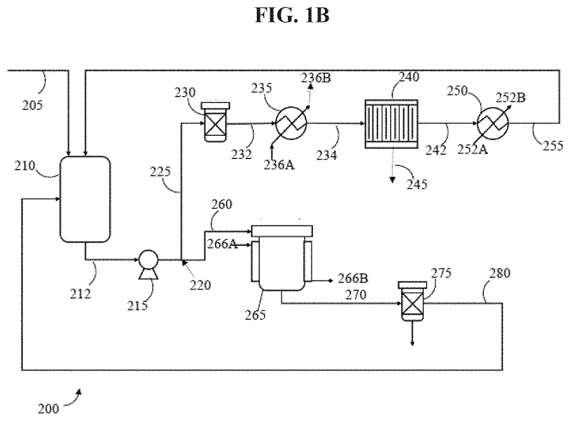

The cell design may include an active circulation option for positive electrolyte to improve positive electrode performance. This type of positive electrolyte-only flow provides a hybrid flow battery as opposed to a flow-battery (as referred in literature) where both positive and negative electrolytes will be circulated. FIG. 1 shows one possible configuration of a hybrid flow battery architecture of the present technology.

A reservoir (e.g., a tank) may be provided to hold most of the positive electrolyte. A recirculation pump may be used to circulate the positive electrolyte through the cell. More specifically, the positive electrolyte may flow through an inlet into the positive electrode compartment, and through the pores of, e.g., a Ni foam current collector and exit through an outlet. The positive electrolyte thus brings the positive electrode material in contact with the current collector where they may undergo the electrochemical charge/discharge reaction. It should be understood that the positive electrode compartment design is expected to vary as needed based upon the type of (liquid or semi-solid) positive electrode active material and positive electrolyte that are being utilized.

Another design feature may be that the molten sodium in the negative electrode compartment is in fluid communication (e.g., via a conduit) to a separate tank (an overflow reservoir) containing a pool of sodium such that only a small amount of it can be present in the negative electrode compartment. Housing the negative electrode in a different tank than in the cell may be advantageous as it could decrease the size of the battery. The sodium overflow reservoir will receive excess sodium during hybrid battery charge and to provide it to the cell during discharge. Alternatively, the battery may be a “stagnant” system where the molten sodium remains within the electrode compartment, e.g., under an inert gas.

It should be noted that the cell may be contained within a temperature controlled environment to ensure that they are operated at the proper temperature. In some embodiments, this temperature may be between 100° C. and 200° C.

In one embodiment the cell operates (charged, and discharged) at the elevated temperatures, while the positive electrolyte tank is held at lower temperature. In this case, a heat generator or heat exchanger maybe used to heat the cell to the desired elevated temperature

In any embodiments, the rechargeable galvanic cell, the first reservoir and the second reservoir may be of a size to hold the respective electrode active materials sufficient for about 1, about 2, about 5, about 10, about 20, or about 50 hours of discharge operation of the cell, or a range between and including any two of the foregoing values.

In another aspect, the present technology provides a battery including one or more (e.g., two or more) galvanic cells as described herein. For example, in any embodiments, the battery may include 1, 2, 3, 4, 5, 10, 15, 20, 25, 30, 40, 50, 60, 80, 100, 150, 200, 250, 300, 350, 400, 450, or 500 galvanic cells as described herein, or a range between and including any two or more of the forgoing values, e.g., 1-500, 2-200 or 50-350 galvanic cells. More than one battery, each including more than one galvanic cells, may be used together to produce battery storage systems. For example, a 350 kW battery may include 320 individual cells, and a battery system designed to provide 2 MW of output may include 50 such batteries with 12,800 individual cells. Hence, in any embodiments, the present technology provides battery systems that include 2 or more batteries, each of which includes 2 or more cells.

In another aspect, the present technology provides a method of operating the rechargeable galvanic cell herein, comprising
charging or discharging the galvanic cell while circulating the mixture of positive electrolyte and positive electrode active material from the second reservoir through the positive electrode compartment and back to the second reservoir;
heating the mixture prior to or upon entering the positive electrode compartment to a first temperature
   from about 100° C. to about 200° C.; and
cooling the mixture after it exits the positive electrode compartment to a second temperature less than the first temperature, e.g., less than 100° C.

In any embodiments, where the mixture of positive electrolyte and positive electrode active material is heated to a temperature above 100° C. before or upon entering the positive electrode compartment, the mixture may be subsequently cooled below that same temperature upon exiting the positive electrode compartment. For example, if the mixture of positive electrolyte and positive electrode active material is heated to a temperature of from 115° C. to 150° C., 175° C. or 200° C., or from 120° C. to 150° C., 175° C. or 200° C., or from 125° C. to 150° C., 175° C. or 200° C., the mixture may subsequently be cooled to a temperature below the lowest temperature, i.e., below 115° C., 120°, or 125° C. In some such embodiments, the temperature range to which the mixture is cooled is 80° C. to less than 115° C., 120°, or 125° C., is 90° C. to less than 115° C., 120°, or 125° C., or is 100° C. to less than 115° C., 120°, or 125° C. In any embodiments, the method includes heating (or cooling) the mixture to a temperature from about 125° C. to a temperature of about 175° C. In any embodiments, the method includes heating (or cooling) the mixture to a temperature from about 125° C. to a temperature of about 150° C. In any embodiments, the method may include cooling (or heating) the mixture after it exits the positive electrode compartment to a temperature of about 80° C. to less than 100° C.

An illustrative embodiment of the present technology will be described with reference to FIG. 1A, which schematically shows a rechargeable alkali metal-sulfur hybrid flow cell 100. The cell includes a negative electrode 110 comprising a negative electrode active material (e.g., sodium or alloys thereof) disposed in a negative electrode compartment 115. The cell also includes a positive electrode 120 comprising a positive electrode active material and disposed in a positive electrolyte 125, comprising the positive electrode active material. An alkali ion conductive ceramic membrane 130 (e.g., NaSICON, Na-β″-alumina, sodium ion conducting garnet-like ceramic, sodium conducing glass ceramic) separates the negative and positive electrode compartments and their contents. The membrane 130 may be secured to the cell housing with O-rings 140A and 140B. The cell may include negative and positive current collectors 150A and 150B respectively, in electrical contact with the negative and positive electrodes. A mixture of the positive electrolyte and positive electrode active material is stored in the reservoir 170 in fluid communication with both a pump 160 and the positive electrode compartment 125. During cell operation, the mixture of positive electrolyte and positive electrode active material is circulated into and out of the positive electrode compartment by the pump. Not shown are optional heat exchangers for controlling the temperature of the mixture, as well as a passive alkali metal reservoir fluidly connected to the negative electrode compartment for storing excess alkali metal. A sodium-sulfur version of this cell was used in the following experiments.

Any of the galvanic cells described herein, e.g., the embodiment of FIG. 1A, may be incorporated into various systems and processes. As an illustrative embodiment only, the Process Flow Diagram (PFD) shown in FIG. 1B depicts one possible system 200 for carrying out a charge and discharge process of the present technology. Sulfur and sodium salts 205—e.g., sodium sulfides and polysulfides are added as needed to the positive electrolyte tank (reservoir) 210 which contains an alcohol, e.g., an alkyl diol as described herein such as, but not limited to, ethylene glycol or propylene glycol. The positive electrolyte 212 is pumped from positive electrolyte tank 210 via fluid driver 215 (e.g., a pump) to a splitter 220, where a portion 225 is then led to a filter 230, which filters out any undissolved solids. The filtered positive electrolyte 232 is then led to a heat exchanger 235, where it is heated to a temperature above 120° C. as described herein, e.g., a temperature of about 125° C. to about 150° C. Heating fluid is led into (236A) and out of (236B) of the heat exchanger to maintain the proper temperature. The heated positive electrolyte 234 is led into a positive electrode compartment of a galvanic cell or series of cells 240 (e.g., see FIG. 1A), where either sodium ions are generated (during discharge) or sodium metal 245 is regenerated from the sodium ions (during recharge) and removed from the cell(s). Upon exiting the galvanic cells, the positive electrolyte 242 is cooled in a second heat exchanger 250 to a temperature below 110° C. as described herein, e.g., to about 80 to about 100° C. The cooled positive electrolyte 255, which (depending on the state of the cell) may include some dissolved elemental sulfur, is recirculated to the positive electrolyte tank 210.

Optionally, at the splitter 220, a portion of the anolyte 260 exiting the anolyte tank is channeled to a crystallizer 265, where the anolyte is cooled to a temperature between about 15° C. and 80° C. by cooling fluid that circulates into (266A) and out of (266B) the crystallizer. Other suitable temperatures in this range may be used, including, e.g., 15° C. to 60° C., 30° C. to 80° C., or 40° C. to 80° C. Sulfur 277 precipitates out, including as crystals, which are then filtered out as the anolyte 270 passes through a sulfur filter 275. The lower temperatures in this part of the system and process not only lower the solubility of sulfur in the anolyte, leading to precipitation/crystallization of the sulfur (S₈), but destabilize Na₂Sₓ, encouraging S₈ formation and precipitation/crystallization. The desulfurized anolyte 280 is then recirculated back to the anolyte tank 210. It will be understood by those of skill in the art, that other methods of removing dissolved sulfur from the anolyte 260 could be employed such as gravimetric methods (e.g., centrifugation). Alternatively, different anolyte solvent systems with lower sulfur solubility could be used at a temperature above sulfur melting point, such that elemental sulfur could be removed as a liquid. Still other sulfur removal techniques such as extraction with a non-polar solvent, immiscible with the anolyte, could be used. It is within the skill in the art to modify the present system and process to use any suitable sulfur removal technique and to make other minor modifications such as, e.g., including additional fluid drivers (e.g., pumps), filters, heat exchangers and the like as needed, and to arrange such components to meet the need at hand.

### EXAMPLES

### Example 1—Conductivity of Na₂Sₓ in Ethylene Glycol

The ionic conductivities of electrolytes comprised of different amounts and types of Na₂Sₓ in ethylene glycol (Univar) were measured in the usual way using an AST52 conductivity probe (Advanced Sensor Technologies, Inc.). The concentration of polysulfide was expressed in terms of the wt % sodium in the mixture. Results are shown in FIG. 2. As the number of sulfur atoms in the polysulfide rose, the conductivity dropped.

### Example 2—Initial Charge & Discharge Cycle of a Sodium-Sulfur Galvanic Cell with Na₂S

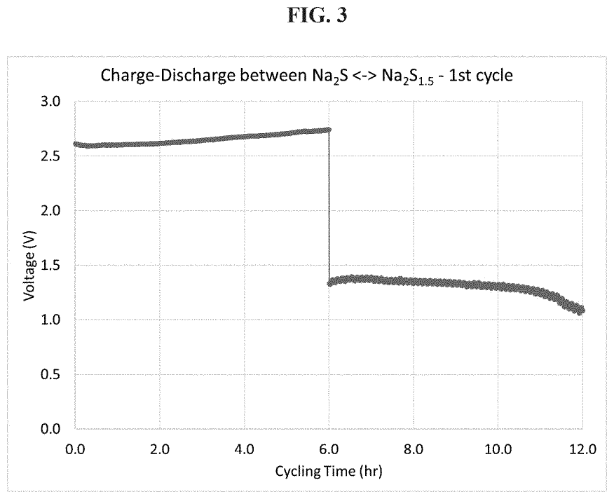

FIG. 3 shows the first charge and discharge cycle at 125° C. of a cell as described herein i.e., a cell of FIG. 1A, at 100 mA per cm² of membrane using molten sodium as the negative electrode, a 1 mm thick NaSICON ceramic membrane, ethylene glycol as the positive electrolyte polar protic solvent with 10 wt % Na₂S (˜6 wt % Na) dissolved in it as the positive electrode active material, and nickel foam as the positive electrode current collector. During the cycling the composition of the positive electrode active material shuttled between Na₂S a Na₂S_{1.5} as measured by atomic absorption using a Perkin Elmer AAnalyst 200 spectrometer or by ICP (sodium) or X-ray fluorescence or ICP (sulfur).

### Example 3—Charge & Discharge Cycling of a Sodium-Sulfur Galvanic Cell with Na₂S₃

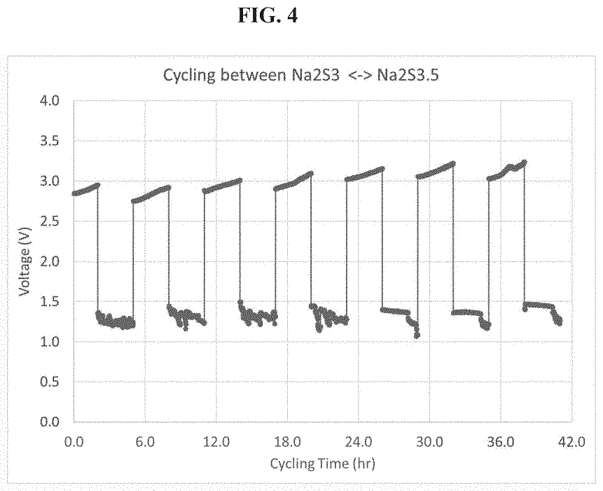

FIG. 4 shows the charge and discharge cycling performance at 125° C. of a cell at 100 mA per cm² of membrane using molten sodium as the negative electrode, a 1 mm thick NaSICON ceramic membrane, ethylene glycol as the positive electrolyte polar protic solvent with 12.5 wt % Na₂S₃ (˜4 wt % Na) dissolved in it as the positive electrode active material, and nickel foam as the positive electrode current collector. During the cycling the composition of the positive electrode active material shuttled between Na₂S₃⇄Na₂S_{3.5}.

### Example 4—Charge & Discharge Cycling of a Sodium-Sulfur Galvanic Cell with Na₂S₅

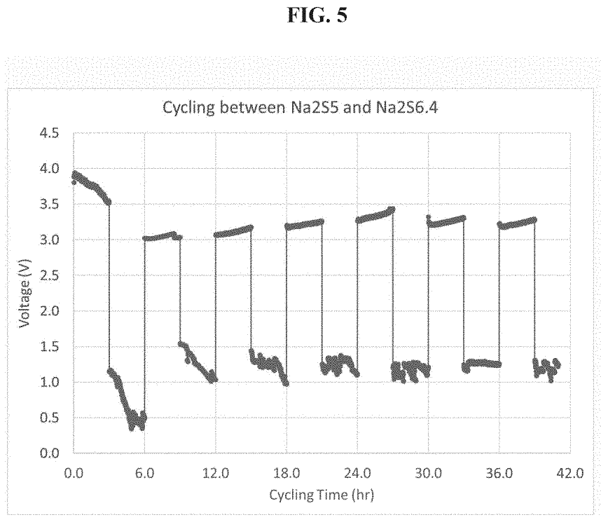

FIG. 5 shows the charge and discharge cycling performance at 125° C. of a cell at 100 mA per square cm of membrane using molten sodium as the negative electrode, a 1 mm thick NaSICON ceramic membrane, ethylene glycol as the positive electrolyte polar protic solvent with 18 wt. % Na₂S₅ (˜4 wt. % Na) dissolved in it as the positive electrode active material, and Nickel foam as the positive electrode current collector. During the cycling the composition of the positive electrode active material was shuttling between Na₂S₅⇄Na₂S_{6.4}.

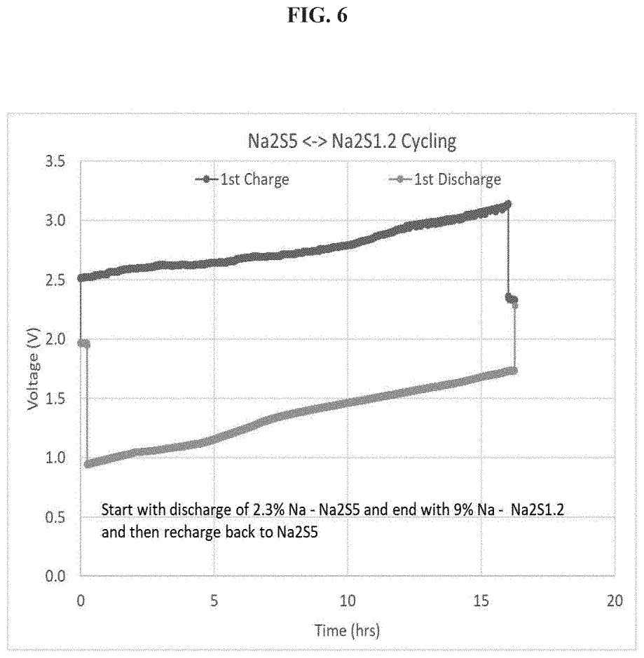

FIG. 6 shows the charge and discharge cycling performance at 120° C. of a cell at 50 mA per square cm of membrane using molten sodium as the negative electrode, a 1 mm thick NaSICON ceramic membrane, ethylene glycol as the positive electrolyte polar protic solvent with 9.7 wt. % Na₂S₅ (˜2.3 wt. % Na) dissolved in it as the positive electrode active material, and Carbon cloth as the positive electrode current collector. During the cycling the composition of the positive electrode active material was shuttling between Na₂S₅⇄Na₂S_{1.2}. The results show a large capacity window (1061 mAh/g) of the Na₂Sₓ cathode in the present galvanic cell.

### Example 5—Initial Charge & Discharge Cycle of a Sodium-Sulfur Galvanic Cell with Na₂S₂

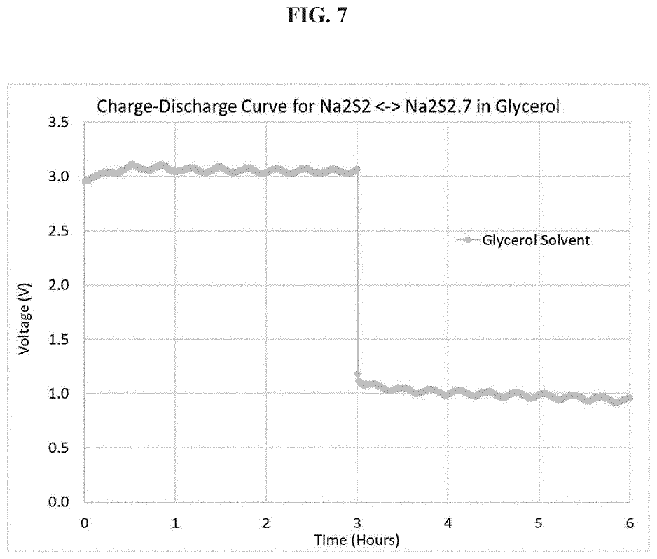

A galvanic cell was constructed as in Example 2 but using glycerol as the positive electrolyte polar organic solvent and 5% Na₂S₂ as the positive electrode material, molten sodium as the negative electrode, and a 1 mm thick NaSICON ceramic membrane, During the cycling the composition of the positive electrode active material shuttled between Na₂S₂⇄Na₂S_{2.7}. FIG. 7 shows the first charge and discharge cycle at 125° C. of a cell as described herein at 50 mA per cm². In a second embodiment, the same cell is operated at a temperature of 150-175 C to improve the current-voltage performance.

### Example 6—Initial Charge & Discharge Cycle of a Sodium-Sulfur Galvanic Cell with Na₂S₂

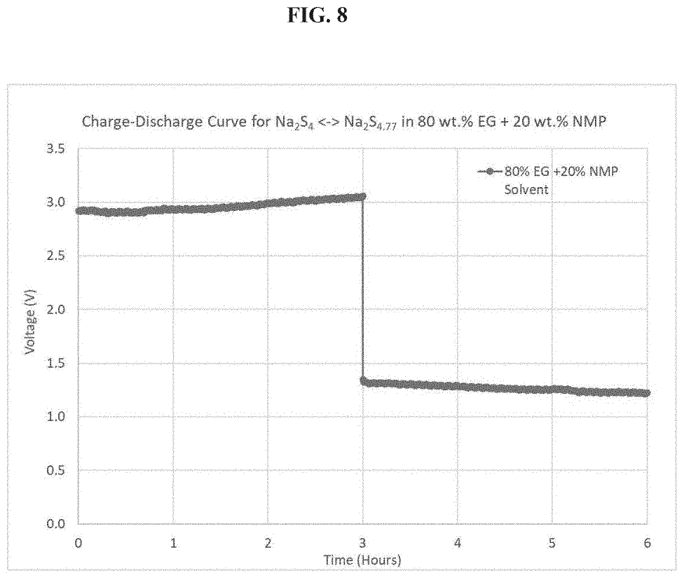

A cell was constructed as in Example 2 but using an 80%:20% w/w mixture of ethylene glycol and NMP as the positive electrolyte polar organic solvent (a mixture of polar protic and polar aprotic solvents) and 5% Na₂S₄ as the positive electrode material. The charge-discharge data is shown in FIG. 8 for shuttling between Na₂S₄<->Na₂S_{4.77}. The presence of polar aprotic solvent NMP assists in solubilizing higher polysulfides (Na₂S₄, Na₂S₅, . . . Na₂S₃₂, and S) and helps extend the capacity range all the way to sulfur.

### Example 7—Initial Charge & Discharge Cycle of a Sodium-Sulfur Galvanic Cell with Na₂S₂

A cell is constructed as in Example 2 but using a β″-alumina membrane of same thickness as the NaSICON ceramic membrane, separating the negative electrode compartment from the positive electrode compartment. Due to the lower conductivity of the β″-alumina membrane, the cell is expected to operate at one third the current density (33 mA per cm²) of the corresponding NaSICON test (FIG. 3). In a second embodiment, a thinner β″-alumina membrane is employed to provide a higher current density than the first embodiment.

### EQUIVALENTS

While certain embodiments have been illustrated and described, a person with ordinary skill in the art, after reading the foregoing specification, can effect changes, substitutions of equivalents and other types of alterations to the PDCs of the present technology or derivatives, prodrugs, or pharmaceutical compositions thereof as set forth herein. Each aspect and embodiment described above can also have included or incorporated therewith such variations or aspects as disclosed in regard to any or all of the other aspects and embodiments.

The present technology is also not to be limited in terms of the particular aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to particular methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing particular aspects only, and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified. Moreover, use of any of the foregoing terms in the description with respect to a particular element or embodiment also contemplates the use of any of the other terms. For example, use of “comprise” with respect to one element or embodiment will also be understood to disclose use of “consisting essentially of” or “consists of” in respect of the same element or embodiment and vice versa.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether or not the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims, along with the full scope of equivalents to which such claims are entitled.

What is claimed is:

1. A rechargeable galvanic cell comprising:
a negative electrode compartment housing a negative electrode active material, wherein
the negative electrode active material comprises a liquid alkali metal wherein the alkali metal is selected from the group consisting of sodium and sodium alloys, and
the negative electrode compartment is in fluid communication with a first reservoir such that the liquid alkali metal may passively flow between the negative electrode compartment and the first reservoir as the galvanic cell charges or discharges;
a positive electrode compartment housing a mixture of a positive electrode active material and a positive electrolyte, wherein
the positive electrode active material comprises elemental sulfur and/or Na₂Sₓ depending on the charge state of the galvanic cell, wherein x has a value between 1 and 32,
the positive electrolyte comprises a polar organic solvent, optionally comprising a polar protic organic solvent, that partially or completely dissolves the Na₂Sₓ, and
the positive electrode compartment is in fluid communication with a pump and a second reservoir such that the pump may circulate the positive electrode active material and positive electrolyte between the second reservoir and the positive electrode compartment during charge or discharge of the galvanic cell; and
a sodium ion conductive ceramic membrane separating the negative electrode compartment from the positive electrode compartment.

2. The rechargeable galvanic cell of claim 1, wherein the negative electrode active material is sodium.

3. The rechargeable galvanic cell of claim 1 further comprising a heat source for maintaining the temperature of the ceramic membrane, the negative electrode active material, and/or the positive electrode active material and positive electrolyte at a temperature from about 100° C. to about 200° C.

4. The rechargeable galvanic cell of claim 3, wherein the heat source is a heat exchanger in fluid communication with the positive electrode compartment and which heats the positive electrolyte to a temperature from about 100° C. to about 200° C. before it enters the positive electrode compartment.

5. The rechargeable galvanic cell of claim 1, wherein the sodium ion conductive ceramic membrane comprises, consists essentially of, or consists of at least one of NaSICON, sodium ion conducting garnet-like ceramic, sodium β″-alumina, and a sodium conducting glass ceramic.

6. The rechargeable galvanic cell of claim 1, wherein the positive electrolyte has a conductivity of at least 30 mS/cm at a temperature of about 100° C. to about 200° C.

7. The rechargeable galvanic cell of claim 1, wherein the polar organic solvent comprises one or more polar protic solvents.

8. The rechargeable galvanic cell of claim 7, wherein the polar protic solvent is selected from the group consisting of an alcohol, a thiol, a primary amide, and a secondary amide, and a mixture of any two or more thereof.

9. The rechargeable galvanic cell of claim 1, wherein the polar organic solvent comprises one or more of 3-propananediol, 2,3-butanediol, 1,4-butanediol, dihydroxybenzyl alcohol, cyclopentane-1,2-diol, cyclopentane-1,3-diol, cyclohexane-1,2-diol, cyclohexane-1,3-diol, cyclohexane-1,4,-diol, diethylene glycol, triethylene glycol, and tetraethylene glycol.

10. The rechargeable galvanic cell of claim 1, wherein the polar organic solvent comprises ethylene glycol.

11. The rechargeable galvanic cell of claim 7, wherein the polar organic solvent comprises an alcohol and a solvent selected from the group consisting of water, acetic acid, acetamide, ammonium hydroxide, tetramethyl ammonium hydroxide, and 1,3-propanedithiol.

12. The rechargeable galvanic cell of claim 1 wherein the positive electrolyte comprises a greater quantity of an alcohol, or an alcohol and another polar protic solvent, and a lesser quantity of a polar aprotic solvent.

13. The rechargeable galvanic cell of claim 12, wherein the polar aprotic solvent comprises, consists essentially of, or consists of at least one of dimethylacetamide, N-methyl-2-pyrrolidone, dimethyl carbonate, diethyl carbonate, tetraglyme, and diglyme.

14. The rechargeable galvanic cell of claim 1 wherein the positive electrolyte comprises 40-96% ethylene glycol, 0-20 wt % water, and 1-40 wt % NMP.

15. The rechargeable galvanic cell of claim 1, further comprising a positive electrode current collector disposed in the positive electrode compartment and electrically connected to the positive electrode active material.

16. The rechargeable galvanic cell of claim 15, wherein the positive electrode current collector comprises, consists essentially of, or consists of nickel foam, nickel mesh, carbon foam, or carbon felt.

17. The rechargeable galvanic cell of claim 1, wherein the positive electrolyte further comprises conductivity enhancers selected from the group consisting of sodium halides, sodium carboxylates, sodium sulfur oxygenates, NaOH, NaOCN, sodium carbonates, and combinations of any two or more thereof.

18. The rechargeable galvanic cell of claim 17, wherein the conductivity enhancers are selected from the group consisting of NaI, NaCl, NaBr, NaOH, HCOONa, CH₃COONa, Na₂CO₃, NaOCN, Na₂SO₄, Na₂SO₃, Na₂S₂O₃, and combinations of any two or more thereof.

19. The rechargeable galvanic cell of claim 1, wherein the first reservoir and the second reservoir are of a size to hold the respective electrode active materials sufficient for about 1 to about 50 hours of discharge operation of the cell.

20. A rechargeable battery comprising, consisting essentially of, or consisting of one or more rechargeable galvanic cells of claim 1.

21. A method of operating the rechargeable galvanic cell of claim 1, comprising, consisting essentially of, or consisting of charging or discharging the galvanic cell while circulating the mixture of positive electrolyte and positive electrode active material from the second reservoir through the positive electrode compartment and back to the second reservoir;
heating the mixture prior to or upon entering the positive electrode compartment to a first temperature from about 100° C. to about 200° C. when the negative electrode active material is sodium or sodium alloy; and
cooling the mixture after it exits the positive electrode compartment to a second temperature less than the first temperature.

22. The method of claim 21, comprising heating the mixture to a temperature from about 125° C. to a temperature of about 175° C.

23. The method of claim 21 comprising heating the mixture to a temperature from about 125° C. to a temperature of about 150° C.

24. The method of claim 21 comprising cooling the mixture after it exits the positive electrode compartment to a temperature of about 80° C. to less than 100° C. or to less than 115° C.
